(19) United States
(12) Patent Application Publication
(10) Pub. No.: US 2025/0011554 A1
(43) Pub. Date: Jan. 9, 2025

(54) METHOD FOR PREPARING POLYMER FILM AND POLYMER FILM PREPARED BY THE METHOD

(71) Applicants: NANODOCKS TECHNOLOGY LIMITED, Hong Kong (CN); CITY UNIVERSITY OF HONG KONG, Hong Kong (CN)

(72) Inventors: Jinlian HU, Hong Kong (CN); Leqi LEI, Hong Kong (CN); Shuo SHI, Hong Kong (CN); Siu Wah WONG, Hong Kong (CN)

(21) Appl. No.: 18/657,038

(22) Filed: May 7, 2024

(30) Foreign Application Priority Data
Jul. 4, 2023 (CN) 202310813124.0

(51) Int. Cl. C08J 5/18; C08K 3/14; D01D 5/00; D01F 6/12; D01F 6/70; D04H 1/413; D04H 1/4318; D04H 1/728; D06M 11/74; D06M 101/22

(52) U.S. Cl. CPC C08J 5/18; C08K 3/14; D01D 5/003; D01F 6/12; D01F 6/70; D04H 1/413; D04H 1/4318; D04H 1/728; D06M 11/74; C08J 2327/16; C08J 2375/04; C08K 2201/005; D06M 2101/22; D06M 2200/00; D10B 2321/042; D10B 2331/10; D10B 2401/04

(57) ABSTRACT

The present invention relates to a method for preparing polymer film, comprising the following steps: i) forming at least one polymer as a first membrane by electrospinning; ii) forming a first mixture by dispersing at least one mid-infrared radiation reflective material into a first liquid; iii) filtering said first mixture, wherein said first membrane is used as a filter membrane, thereby depositing said at least one mid-infrared radiation reflective material on said first membrane to form a second membrane, and iv) drying said second membrane to form a third membrane; characterized in that, said at least one polymer is selected from polyvinylidene fluoride and/or polyurethane.

### FIELD OF THE INVENTION

The invention relates to a crack-free high-reflective composite warmth retention film (also known as a crack-free low-emission warmth retention film) and a preparation method thereof, in particular to a crack-free high-reflective composite warmth retention film comprising mid-infrared radiation high-reflective functional material and its preparation method.

### BACKGROUND OF THE INVENTION

Indoor heating in residential and commercial buildings accounts for a large part of the world's total energy consumption. For example, 47% of global energy is still used solely for indoor heating, of which 42% is used exclusively for heating residential buildings. In order to reduce indoor heating, the existing technology usually focuses on improving the insulation requirements of buildings, rather than focusing on people. If heating and warmth retention can be managed directly based on people's conditions, a large amount of energy can be saved. Energy-saving methods that manage heating and warmth retention directly based on the person's situation are called “personal thermal management”, which mainly perform local thermal control of the direct environment around the human body to reduce the energy demand for indoor temperature regulation. Therefore, the development of materials and systems that can heat the human body in an energy-saving manner is extremely urgent to alleviate the energy crisis and global warming.

Under normal circumstances, the human body with a normal skin temperature of about 34° C. mainly emits mid-infrared radiation in the wavelength range of 7-14 μm (also known as the atmospheric window). About 60% of the heat generated by the human body is dissipated through infrared radiation. Maintaining human body temperature at a relatively constant level through heating is crucial to maintaining human thermal comfort and various human biological processes.

Traditional textiles only act as an insulating layer to prevent heat conduction and convection, but have no ability to dissipate radiative heat. Traditional textiles exhibit higher mid-infrared radiation rates, therefore, through traditional textiles, the heat generated by the human body is easily transported to cold outside space.

Passive radiation heating is mainly an energy-free method to prevent the loss of heat from objects through atmospheric windows to outer space, which is a promising method of keeping warm to solve the problem of excessive energy consumption. By developing passive radiative heating textiles, it is possible to save even more energy. Therefore, manipulating infrared radiation by adjusting the thermal radiation properties of textiles has the potential to greatly change the localized heating of the human body indoors.

However, there is still a lack of an ideal passive radiation heating textile, which has both the best passive radiation heating ability and good wearability. This is mainly manifested in the combination between materials with warmth retention properties and textiles formed from wearable films. That is, for example, whether the thermal functional material can evenly exist on the surface of the wearable film, whether there are cracks in the wearable film, whether it affects the moisture permeability, whether it affects its inherent mechanical properties, etc.

Although there are very few radiant heating textiles on the market, these textiles all have serious shortcomings and cannot provide warmth retention performance and meet basic indicators related to wearable performance. The Mylar blanket, for example, consists of a solid plastic sheet coated with a dense metallic reflective film, that lacks breathability, making it uncomfortable for daily wear. Omni-Heat technology prints sparse metallic dots on the inside of the garment to reflect human body heat, but this technology has problems with low reflectivity and poor passive radiation heating performance. Recently developed silver nanowire-coated textiles have low infrared reflectivity, about 40%, and only raise the temperature of the human body by 0.9° C. higher than ordinary textiles. Additionally, a nanophotonic structured textile was fabricated by depositing gold and germanium coatings on the dopamine hydrochloride (PDA)-treated surface of polyethylene, which improved the local heating performance by 3.8° C. but had poor mechanical properties (elongation strain rate was lower than 40%).

In view of the wearable high-reflective composite warmth retention film in the existing technology, there is always a dilemma between the best passive radiation heating performance and good wearability for the resulting thermal material. First of all, there is not enough infrared reflectivity to hinder the local heat energy dissipation of the human body. Secondly, it is required to have a comfortable wearing experience without affecting the thermal management performance.

In summary, the present invention provides a crack-free high-reflective composite warmth retention film based on an electrospinning film and comprising mid-infrared radiation high-reflective functional material (hereinafter referred to as “composite warmth retention film of the present invention”), and its preparation method. The film introduces an electrospinning film and a mid-infrared radiation high-reflective functional material. The functional material is used as a mid-infrared radiation reflector for temperature regulation technology and has mid-infrared radiation high-reflective properties, thus the film has the advantages of better warmth retention performance, breaking strength, moisture permeability and wearability. The composite warmth retention film of the present invention is expected to become a promising textile material that optimizes the mid-infrared radiation rate, and is applied in the fields of warm and breathable clothing, building structural fabric membranes and smart wearables.

### SUMMARY OF INVENTION

The first aspect of the present invention relates to a method for preparing polymer film, comprising the following steps:
i) forming at least one polymer as a first membrane by electrospinning;
ii) forming a first mixture by dispersing at least one mid-infrared radiation reflective material into a first liquid;
iii) filtering said first mixture, wherein said first membrane is used as a filter membrane, thereby depositing said at least one mid-infrared radiation reflective material on said first membrane to form a second membrane, and
iv) drying said second membrane to form a third membrane;

In some embodiments, said at least one polymer is selected from polyvinylidene fluoride and/or polyurethane.

In some embodiments, in step i), dissolving said at least one polymer in a solvent at 50-80° C.

Preferably, the concentration of said at least one polymer in said solvent is 50% by weight or less.

Preferably, the concentration of said at least one polymer in said solvent is 30% by weight or less.

Preferably, the concentration of said at least one polymer in said solvent is 15-30% by weight.

Preferably, the concentration of said at least one polymer in said solvent is 5-30% by weight.

Preferably, said solvent is dimethylformamide solution.

In some embodiments, said mid-infrared radiation reflective material is metal carbide.

In some embodiments, the concentration of the at least one metal carbide in said first liquid is 2% by weight or less.

Preferably, the concentration of the at least one metal carbide in said first liquid is 0.1% by weight or less.

Preferably, the concentration of the at least one metal carbide in said first liquid is 0.02% by weight or less.

Preferably, the concentration of the at least one metal carbide in said first liquid is 0.01-0.05% by weight.

Preferably, the particle size of the at least one metal carbide is 5 μm or less.

Preferably, the particle size of the at least one metal carbide is 0.2-1 μm.

Preferably, the particle size of the at least one metal carbide is 0.1-1 μm.

In some embodiments, the at least one metal carbide is titanium carbide.

Preferably, said first liquid is water; and in step ii), dispersing titanium carbide in water at concentration 10-20 mg/ml.

Preferably, the particle size of titanium carbide is 0.1-1 μm.

Preferably, the concentration of titanium carbide in said first liquid is 0.05% by weight or less.

Preferably, the concentration of titanium carbide in said first liquid is 0.01-0.02% by weight.

In some embodiments, in step iii), said filtration is vacuum filtration.

In some embodiments, in step i), 50% by weight or less of the at least one polymer is dissolved in 50% by weight or more of dimethylformamide organic solvent, and in step ii), the concentration of the at least one metal carbide in the first liquid is 0.05% by weight or less.

In some embodiments, in step i), 50% by weight or less of the at least one polymer is dissolved in 80% by weight or more of dimethylformamide organic solvent, and in step ii), the concentration of the at least one metal carbide in the first liquid is 0.05% by weight or less.

The second aspect of the present invention relates to a polymer film prepared according to the method for preparing a polymer film as described in the first aspect, characterized in that, the weight ratio of the mid-infrared high-reflective material in the third membrane is 10%.

Advantageously, said third membrane has at least one of the following physical properties:
thickness is 0.01-0.02 mm;
warmth retention temperature >4° C. according to GB/T 2423.1 standard;
moisture permeability >10000 g·m²/24 h; and
breaking strength >12 MPa.

Advantageously, said third membrane is crack-free.

The third aspect of the present invention relates to a polymer film, comprising: a polymer film, comprising polyvinylidene fluoride and/or polyurethane; at least one mid-infrared radiation reflective material deposited on said polymer film; characterized in that, said polyvinylidene fluoride and/or polyurethane is formed as a first membrane by electrospinning; said at least one mid-infrared radiation reflective material is dispersed into a first liquid to form a first mixture; said at least one mid-infrared radiation reflective material is deposited on said polymer film by filtering said first mixture with said first membrane; and said at least one mid-infrared radiation reflective material in said polymer film is 10% by weight.

### DESCRIPTION OF THE DRAWINGS

The present invention provides the following drawings, which are intended to introduce various embodiments of the present invention in detail and are not intended to limit the present invention, in which:

FIG. 1—a process flow chart for preparing the composite warmth retention film of the present invention.

FIG. 2—thermal images of the warmth retention performance.

### DETAILED DESCRIPTION OF PREFERRED EMBODIMENTS OF THE INVENTION

The present disclosure is now presented by way of example with reference to the accompanying drawings in the following paragraphs. Objects, features and aspects of the disclosure are disclosed or apparent from the following description. It will be understood by those of ordinary skill in the art that the following discussion is illustrative only. The description of the embodiments is only to further illustrate the features and advantages of the present invention, but is not intended to limit the present invention.

Unless otherwise specified, all chemicals in the specification are commercially available and used as received without special handling, which may include impurities such as residual solvents or by-products.

In embodiments, the content of polymer is 5-30 parts by weight, and is not equal to 0.

In embodiments, the mid-infrared radiation high-reflective functional material is selected from titanium carbide. The size of the mid-infrared radiation high-reflective functional material is 0-5 μm. The content of the mid-infrared radiation high-reflective functional material is 0-0.1 parts by weight.

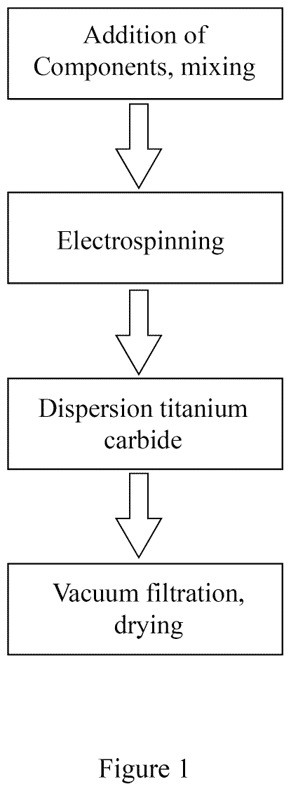

FIG. 1 is an overview of the method for preparing the composite warmth retention film of the present invention, which includes the following steps:
1) Dissolve 5-30% by weight of polymer in 70-95% by weight of dimethylformamide organic solvent. Stir at 60° C. to obtain an electrospinning solution;
2) The electrospinning solution is used to form a film using electrospinning to obtain an initial polymer film;
3) Disperse 0-0.02% titanium carbide in the aqueous solution to obtain a 10 mg/ml-20 mg/ml titanium carbide solution;
4) Using the initial polymer film as a filter membrane, the titanium carbide solution is deposited on the electrospun film using vacuum filtration technology, and after drying, the composite warmth retention film of the present invention is obtained.

In the above specific preparation process, the polymer is first dissolved in the solvent according to the ingredient ratio, and the electrospinning solution is obtained after stirring. During this process, the above raw materials are preferably mixed and stirred at high speed at 60° C. until the polymer is completely dissolved, thereby obtaining an electrospinning solution. In a specific embodiment, the solution is selected from dimethylformamide solution. In this embodiment, the above solution is selected to fully dissolve the polymer, and the solution does not contain highly toxic chemicals, and the prepared product has little toxic residue, little environmental pollution.

After obtaining a fully dissolved polymer electrospinning solution, the polymer solution is formed into a film by electrospinning to obtain the initial polymer film; the above-mentioned electrospinning process is a technical means well known to those skilled in the art, and the present invention has no special limitations on this. For example: electrospinning parameters can be: electrospinning voltage is 18 KV, syringe advancement rate is 0.5 mL/h, and collection distance is 15 cm.

A certain proportion of titanium carbide high-reflective functional material powder is evenly dispersed in 10 ml of aqueous solution, which is the titanium carbide solution obtained. The above-mentioned dispersion processes are all technical means well known to those skilled in the art, and the present invention has no special limitations on this. Example, dispersion process, can be selected from ultrasonic dispersion process.

Finally, the present invention uses the initial polymer film obtained above as a filter membrane, and uses vacuum filtration technology to filter the titanium carbide solution and dry it to obtain a composite warmth retention film.

After the above preparation method, the thickness of the composite warmth retention film prepared by the present invention is 0.01-0.02 mm, the moisture permeability is >10000 g·m²/24 h, and the warmth retention performance is >4° C.

In order to further understand the present invention, the following specific examples describe the crack-free high-reflective composite warmth retention film and its preparation method in more detail.

### Example 1: Preparation of Polyvinylidene Fluoride-Polymer Film

First, 80% by weight of dimethylformamide solution was vigorously dispersed in the flask.

Then, 20% by weight of polyvinylidene fluoride was slowly added to 80% by weight of dimethylformamide solution under vigorous stirring at 60° C. Then, through electrospinning technology, using a plastic syringe containing a homogeneous polymer solution (5 ml), and adjusting the electrospinning parameters, adding a voltage of 20 k V and a syringe speed of 1 ml/h, setting the distance between the rolling collector and the syringe needle to 15 cm, a polyvinylidene fluoride-polymer film with a thickness of 0.015 mm was prepared.

### Example 2: Preparation of Polyvinylidene Fluoride/Polyurethane-Polymer Film

First, 80% by weight of dimethylformamide solution was vigorously dispersed in the flask.

Then, 10% by weight of polyvinylidene fluoride and 10% by weight of polyurethane were slowly added to the dimethylformamide solution under vigorous stirring at 60° C. Then, through electrospinning technology, using a plastic syringe containing a homogeneous polymer solution (5 ml), and adjusting the electrospinning parameters, adding a voltage of 20 kV and a syringe speed of 1 ml/h, setting the distance between the rolling collector and the syringe needle to 15 cm, a polyvinylidene fluoride/polyurethane-polymer film with a thickness of 0.012 mm was prepared.

### Example 3: Preparation of Polyurethane-Polymer Film

First, 80% by weight of dimethylformamide solution was vigorously dispersed in the flask.

Then slowly add 20% by weight of polyurethane to the dimethylformamide solution under vigorous stirring at 60° C. Then, through electrospinning technology, using a plastic syringe containing a homogeneous polymer solution (5 ml), and adjusting the electrospinning parameters, adding a voltage of 20 kV and a syringe speed of 1 ml/h, setting the distance between the rolling collector and the syringe needle to 15 cm, a polyurethane-polymer film with a thickness of 0.010 mm was prepared.

### Example 4: Preparation of Polyvinylidene Fluoride-Crack-Free High-Reflective Composite Warmth Retention Film

First, 80% by weight of dimethylformamide solution was vigorously dispersed in the flask.

Then slowly add 20% by weight of polyvinylidene fluoride to the dimethylformamide solution under vigorous stirring at 60° C. Then, through electrospinning technology, using a plastic syringe containing a homogeneous polymer solution (5 ml), and adjusting the electrospinning parameters, adding a voltage of 20 k V and a syringe speed of 1 ml/h, setting the distance between the rolling collector and the syringe needle to 15 cm. Finally, an electrospun polyvinylidene fluoride film was obtained.

Then add 0.01% titanium carbide powder by weight into 10 ml of aqueous solution, and obtain a uniform titanium carbide solution through ultrasonic process. Finally, a 5*5 cm electrospun polyvinylidene fluoride film is used as a filter membrane, and titanium carbide molecules are deposited on the electrospun polyvinylidene fluoride film through a vacuum filtration process. Put it into a vacuum oven at 30° C. and dry it for 24 hours to prepare a polyvinylidene fluoride-crack-free high-reflective composite warmth retention film with a thickness of 0.02 mm.

Thermogravimetric analysis results show that the weight ratio of titanium carbide in the composite warmth retention film of the present invention is about 10%.

### Example 5: Preparation of Polyvinylidene Fluoride/Polyurethane-Crack-Free High-Reflective Composite Warmth Retention Film

First, 80% by weight of dimethylformamide solution is vigorously dispersed in the flask.

Then, 10% by weight of polyvinylidene fluoride and 10% by weight of polyurethane were slowly added to the dimethylformamide solution under vigorous stirring at 60° C. Then, through electrospinning technology, using a plastic syringe containing a homogeneous polymer solution (5 ml), and adjusting the electrospinning parameters, adding a voltage of 20 kV and a syringe speed of 1 ml/h, setting the distance between the rolling collector and the syringe needle to 15 cm. Finally, an electrospun polyvinylidene fluoride/polyurethane film was obtained.

Then add 0.02% titanium carbide powder by weight into 10 ml of aqueous solution, and obtain a uniform titanium carbide solution through ultrasonic technology. Finally, a 5*5 cm electrospun vinylidene fluoride film is used as a filter membrane. Titanium carbide molecules are deposited on the electrospun vinylidene fluoride film through a vacuum filtration process. Put it into a vacuum oven at 30° C. and dry it for 24 hours to prepare a polyvinylidene fluoride/polyurethane-crack-free high-reflective composite warmth retention film with a thickness of 0.018 mm.

Thermogravimetric analysis results show that the weight ratio of titanium carbide in the composite warmth retention film of the present invention is about 10%.

### Example 6: Preparation of Polyurethane-Crack-Free High-Reflective Composite Warmth Retention Film

First, 80% by weight of dimethylformamide solution is vigorously dispersed in the flask.

Then slowly add 20% by weight of polyurethane to the dimethylformamide solution under vigorous stirring at 60° C. Then, through electrospinning technology, using a plastic syringe containing a homogeneous polymer solution (5 ml), and adjusting the electrospinning parameters, adding a voltage of 20 kV and a syringe speed of 1 ml/h, setting the distance between the rolling collector and the syringe needle to 15 cm. Finally, an electrospun polyurethane film was obtained.

Then add 0.01% titanium carbide powder by weight into 10 ml of aqueous solution, and obtain a uniform titanium carbide solution through ultrasonic process. Finally, a 5*5 cm electrospun vinylidene fluoride film is used as a filter membrane. Titanium carbide molecules are deposited on the electrospun vinylidene fluoride film through a vacuum filtration process. Put it into a vacuum oven at 30° C. and dry it for 24 hours to prepare a polyurethane-crack-free high-reflective composite with a thickness of 0.015 mm.

Thermogravimetric analysis results show that the weight ratio of titanium carbide in the composite warmth retention film of the present invention is about 10%.

### Performance Test

Test the polymer film prepared in Examples 1-3 and the crack free high reflective composite warm retention film prepared in Examples 4-6 for warmth retention performance, moisture performance (WVP), and breaking strength.

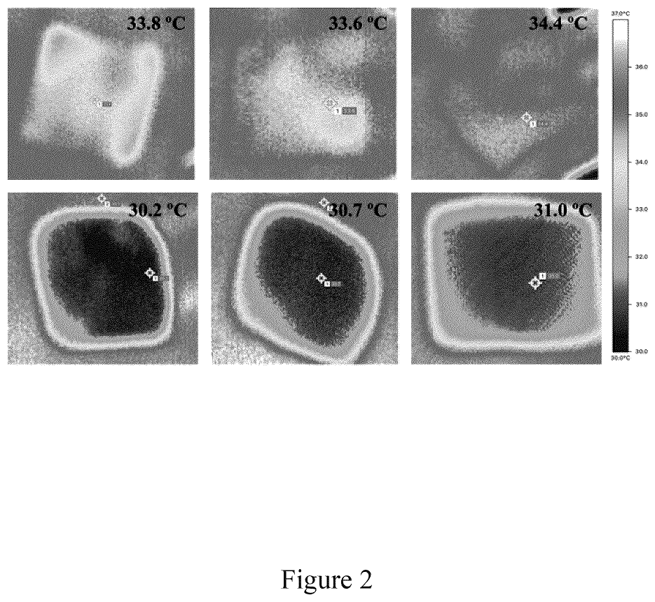

The warmth retention performance test adopts the GB/T 2423.1 standard and is tested by the German TESTO 871 infrared thermal imager. The film prepared in Examples 1-6 is covered on the palm of the hand with a relatively constant temperature, and the infrared thermal imager can automatically collect the measured object surface temperature and image the measured temperature, and then perform image processing, analysis, storage and output. FIG. 2 shows thermal images of the warmth retention performance.

The moisture permeability test adopts the ASTM E96 BW standard and is conducted using the Haida HD-100T constant temperature and humidity chamber (the constant temperature and humidity chamber conditions are set at: temperature 23° C., relative humidity 50%).

The tensile breaking strength test adopts the ASTM D 882 standard and is conducted with an Instron 5566 tensile machine (tensile machine conditions are set as: temperature 23° C., relative humidity 50%).

The polymer film prepared in Examples 1-3 and the crack-free high-reflective composite warmth retention film prepared in Examples 4-6 were tested for warmth retention performance, moisture permeability, and breaking strength. The results are shown in Table 1:

| | warmth retention | moisture | |
|---|---|---|---|
| | performance | permeability | breaking strength |
| item | (° C.) | (g · m² d⁻¹) | (MPa) |
| Example 1 | 1.4 | 17139.0 | 15.6 |
| Example 2 | 1.2 | 19342.3 | 7.5 |
| Example 3 | 0.6 | 18055.4 | 12.7 |
| Example 4 | 4.8 | 6953.5 | 12.5 |
| Example 5 | 4.3 | 12920.8 | 12.3 |
| Example 6 | 4.0 | 16586.6 | 15.2 |

Through the comparison of Example 1 and Example 4, Example 2 and Example 5, and Example 3 and Example 6, it can be seen from the warmth retention performance results that with the addition of high-reflective functional material, the warmth retention temperature of the resulting film will be increased from about 1.4° C. to 4.8° C. It can be seen that with the addition of high-reflective functional material, the warmth retention performance of the resulting film is significantly enhanced. Specifically, the introduction of mid-infrared radiation high-reflective functional material changes the molecular bond vibration of the film's mid-infrared radiation wavelength. The bond vibration is less, the mid-infrared radiation emissivity is low, and the reflectivity is high. Adding mid-infrared radiation high-reflective functional material to the crack-free high-reflective composite warmth retention film can improve heat dissipation within the human body radiation range.

In Examples 4-6, the composite warmth retention film of the present invention comprises a high-reflective functional material such as titanium carbide. Titanium carbide is a known ceramic material and has affinity for the polymer selected in the present invention, such as polyvinylidene fluoride/polyurethane, and therefore can form supramolecular bonds such as electrostatic and/or hydrogen bonds with the polymer.
For example, when the selected polymer is or comprise polyvinylidene fluoride, titanium carbide adheres to the polymer surface through static electricity between titanium carbide and the polymer. For example, when the selected polymer is or comprises polyurethane, polyurethane contains rich urethane groups to form supramolecular bonds with functional materials, The adjustment of the polyurethane matrix structure by the high-reflective functional material can improve the binding force with the high-reflective functional material and provide good mechanical properties, which is beneficial to the improvement of wearable performance.

Therefore, the present invention can change the structure of the polymer by adding a high-reflective functional material such as titanium carbide, thereby enhancing the mechanical properties, so that the composite warmth retention film of the present invention does not have a crack structure. During use, there will be no phenomenon of large pieces of high-layer reflective material falling off, thus avoiding the problem of reduced warmth retention performance in later use.

The polymer film is prepared by electrospinning, which changes the micron-level pore size of the polymer film and forms a strong bonding force between fibers during the fiber stretching process, thereby improving and adjusting the warmth retention performance, moisture permeability, breaking strength and mechanical properties of the film, thus making the film have good wearable performance. It can be seen from the test results in Table 1 that the moisture permeability remains above 6900 g·m²d⁻¹, and the breaking strength remains above 7.5 MPa.

It can be seen from the comparison between Example 1 and Examples 4-6 that as the content of the high-reflective functional material increases, the warmth retention performance of the resulting film shows an increasing trend first.

Specifically, when the weight ratio of the high-reflective functional material and the polymer material is within the overall range of 0-0.05:0-30, when the weight ratio of the high-reflective functional material and the polymer material is within the range of 0.01-0.02:10-30 (see Examples 4-6), the warmth retention performance of the film can be further improved. The warmth retention temperature is increased from about 1.4° C. to more than 4.0° C., while the moisture permeability is maintained at 6900 g·m² d⁻¹ above, the breaking strength remains above 12.0 MPa.

Furthermore, when the weight ratio of the high-reflective functional material to the polymer material is 0.01-0.02:5-30 (see Examples 5-6), the moisture permeability of the film can be further improved. The moisture permeability can be further improved to more than 12000 g·m²/24 h, at the same time, breaking strength reaches more than 12.0 MPa.

Furthermore, when the weight ratio of the high-reflective functional material to the polymer material is 0.01-0.02:15-30 (see Example 6), the moisture permeability and breaking strength of the film can be further improved, and the film's moisture permeability and breaking strength can be further improved. The moisture permeability is increased to more than 16000 g·m²/24 h, and at the same time, the breaking strength reaches more than 15.0 MPa.

By controlling different proportions of polymers and high-reflective functional materials, the present invention can prepare crack-free high-reflective composite warmth retention film with different warmth retention performance, ultra-warm, better moisture permeability, stronger mechanical properties, and better durability. In addition, the design process for preparing the crack-free high-reflective composite warmth retention film in the present invention is streamlined, simple, and is easy to realize industrialization.

This article applies specific examples to explain the principles and implementation methods of the present invention. The above examples are only used to help understand the methods and core ideas of the present invention, including the best method, and also enable any skilled person in the art to practice the present invention, including manufacturing and using any device or system, and implementing any combined method. It should be pointed out that for those skilled in the art, without departing from the principles of the present invention, several improvements and modifications can be made to the present invention, which also fall within the scope of protection of the claims of the present invention. The scope of protection of the present invention is limited by the claims, and may include other embodiments that those skilled in the art could think of. If these other embodiments have structural elements that are similar to the textual expression of the claims, or if they include equivalent structural elements that are not substantially different from the textual expression of the claims, then these other embodiments should also be included within the scope of the claims. It should be understood that, each specific numerical point of the parameters described in the context of the embodiments (such as weight ratio, particle size, temperature, etc.) can be used as the end value of the numerical range of the said parameter in the embodiments of the present invention. In other words, said end value is also included in the numerical range. It should be understood that in embodiments according to the present invention, each numerical value within the said numerical range can also be the end value of another numerical range of the said parameter.

What is claimed is:

1. A method for preparing polymer film, comprising the following steps:
i) forming at least one polymer as a first membrane by electrospinning;
ii) forming a first mixture by dispersing at least one mid-infrared radiation reflective material into a first liquid;
iii) filtering said first mixture, wherein said first membrane is used as a filter membrane, thereby depositing said at least one mid-infrared radiation reflective material on said first membrane to form a second membrane, and
iv) drying said second membrane to form a third membrane;
characterized in that,
said at least one polymer is selected from polyvinylidene fluoride and/or polyurethane.

2. The method for preparing polymer film according to claim 1, characterized in that, in step i), dissolving said at least one polymer in a solvent at 50-80° C.

3. The method for preparing polymer film according to claim 2, characterized in that, the concentration of said at least one polymer in said solvent is 50% by weight or less.

4. The method for preparing polymer film according to claim 2, characterized in that, the concentration of said at least one polymer in said solvent is 15-30% by weight.

5. The method for preparing polymer film according to claim 2, characterized in that, the concentration of said at least one polymer in said solvent is 5-30% by weight.

6. The method for preparing polymer film according to claim 2, characterized in that, said solvent is dimethylformamide solution.

7. The method for preparing polymer film according to claim 1, characterized in that, said at least one mid-infrared radiation reflective material is metal carbide.

8. The method for preparing polymer film according to claim 7, characterized in that, the concentration of said metal carbide in said first liquid is 2% by weight or less.

9. The method for preparing polymer film according to claim 7, characterized in that, the concentration of said metal carbide in said first liquid is 0.1% by weight or less.

10. The method for preparing polymer film according to claim 7, characterized in that, the concentration of said metal carbide in said first liquid is 0.01-0.05% by weight.

11. The method for preparing polymer film according to claim 7, characterized in that, the particle size of said metal carbide is 5 μm or less.

12. The method for preparing polymer film according to claim 7, characterized in that, the particle size of said metal carbide is 0.1-1 μm.

13. The method for preparing polymer film according to claim 8, characterized in that:
said metal carbide is titanium carbide;
said first liquid is water; and in step ii), dispersing titanium carbide in water.

14. The method for preparing polymer film according to claim 11, characterized in that:
said metal carbide is titanium carbide;
said first liquid is water; and in step ii), dispersing titanium carbide in water.

15. The method for preparing polymer film according to claim 13, characterized in that, the particle size of titanium carbide is 0.1-1 μm, and the concentration of titanium carbide in said first liquid is 0.05% by weight or less.

16. The method for preparing polymer film according to claim 14, characterized in that, the particle size of titanium carbide is 0.1-1 μm, and the concentration of titanium carbide in said first liquid is 0.05% by weight or less.

17. The method for preparing polymer film according to claim 1, characterized in that, in step iii), said filtration is vacuum filtration.

18. A polymer film, comprising:
a polymer film, comprising polyvinylidene fluoride and/or polyurethane;
at least one mid-infrared radiation reflective material deposited on said polymer film;
characterized in that,
said polyvinylidene fluoride and/or polyurethane is formed as a first membrane by electrospinning;
said at least one mid-infrared radiation reflective material is dispersed into a first liquid to form a first mixture;
said at least one mid-infrared radiation reflective material is deposited on said polymer film by filtering said first mixture with said first membrane; and
said at least one mid-infrared radiation reflective material in said polymer film is 10% by weight.

19. The polymer film according to claim 18, characterized in that, said third membrane has at least one of the following physical properties:
thickness is 0.01-0.02 mm;
warmth retention temperature >4° C. according to GB/T 2423.1 standard;
moisture permeability >10000 g·m²/24 h; and
breaking strength >12 MPa.

20. The polymer film according to claim 18, characterized in that, said third membrane is crack-free.
